(19) United States
(12) Patent Application Publication
(10) Pub. No.: US 2020/0165814 A1
(43) Pub. Date: May 28, 2020

(54) EXTENSION ELEMENT IN A SEALING SYSTEM

(71) Applicant: MTC Brattberg AB, Karlskrona (SE)

(72) Inventors: Joakim Andersson, Karlskrona (SE); Ola Fagerberg, Karlskrona (SE)

(21) Appl. No.: 16/696,139

(22) Filed: Nov. 26, 2019

(30) Foreign Application Priority Data
Nov. 28, 2018 (SE) 1851481-0

(51) Int. Cl. E04B 1/76; H02G 3/22

(52) U.S. Cl. CPC E04B 1/76; H02G 3/22

(57) ABSTRACT

A sealing system for improved heat resistance in a partition wall. A frame element forms an enclosed passage, with the frame element formed by a substantially flat member arranged perpendicular to the partition wall such that a shoulder extending from the partition wall is formed wherein the space within the frame element and the second section is to be fitted with insert blocks of a fire resistant material fitted around cable, etc. for sealing therearound. An extension element encloses the shoulder of the frame element and extends the enclosed passage for the cable, etc. The extension element includes a first and a second section. The first section includes a first fastening arrangement for attaching the extension element to the shoulder. The second section is formed so that an extended enclosed passage formed by the second section is substantially equal to the enclosed passage formed by the frame element.

### FIELD OF THE INVENTION

The present invention relates to extension element for improving heat resistance of a sealing system installed in a partition wall, and a sealing system comprising said extension element.

### BACKGROUND OF THE INVENTION

Within many different technical fields, like for example merchant ships, offshore platforms and buildings with content of high importance there are several safety aspects that must be considered to avoid severe damages to the content within the structure as well as peoples working in, or close to, the area in case of accidents like for example fire or leaking water or gas from the outside or within the platform, ship or building.

In case of explosion, fire or leaking water the fire and/or leaking water and gas are often spread along wires, cables or pipes and in order to stop, or at least delay, the fire, water or gas from spreading within the structure, each cable, wire or pipe must be sealed where they are lead through partition walls within the platform, ship or building.

One frequently used sealing system that provide a reliable sealing of cables, wires or pipes extending through partition walls involves a metal frame permanently installed in the partition wall to provide a passage of a predetermined size for the cables, wires or pipes in the desired area of the partition wall. The cables, wires or pipes are during installation lead through the frame. The space within the frame is during installation of the sealing system filled with insert blocks packed in layers within the frame to completely fill the space within the frame. Each insert block consists of two insert block halves each provided with a semi-circular groove in one side of the block half such that a circular passage is formed through the insert block when the two block halves are put together. Each cable, wire or pipe extending through the frame is fitted in an insert block and packed within the frame. The outside dimensions of the insert blocks are selected so that a predetermined number of insert blocks have a size corresponding to the space within the frame. After the blocks are packed side by side in layers in the intended position a pressure applying device is arranged in the top part of the frame. The pressure applying device, upon activation, applies a pressure on the blocks to press the blocks together and provide the desired sealing around the cables, wires or pipes within the frame.

However, in order to make it possible to add further pipes, wires or cables extending via the frame in the partition wall, the frame preferably is selected slightly larger than actually required. The frame is then filled with insert halves without any pipe, wire or cable extending through the insert halves and in order to seal the space within the frame each groove is sealed by an insert plug fitted in the recess to close the groove. The insert plug has a radius corresponding to the radius of the groove to ensure that the groove is sealed once the pressure is applied.

Unfortunately, it has turned out that with increasing safty standards there is need to further enhance the system for sealing of the cable, wire or pipe going through the partition wall providing a passage for the cables, wires or pipes and facilitate related insulation.

### SUMMARY OF THE INVENTION

To this end there is provided an element and an improved sealing system that to at least some extent fulfils the needs defined above.

Preferred embodiments of the extension element, and the improved sealing system are outlined in the dependent claims.

According to a first aspect of the present inventive concept there is provided an extension element according to claim 1 which provides for improved heat resistance in a sealing system for a partition wall. The extension element according to claim 1 further facilitates leading cables, wires or pipes through a partition wall and facilitates insulation of a partition wall. The extension element also provides for extension of an enclosed passage in the partition wall which in turn provides for extension of a sealing system permanently secured in the partition wall. Additionally, the extension element facilitates applying extra insulation onto the partition wall around the extended frame permanently secured in the partition wall.

In one embodiment of the extension element, said first section is at least partly enclosing said second section and said first section is attached to said second section by a second fastening means. This embodiment provides for a facilitated installation of the extension element and a strong assembly of the extension element is achieved.

In one embodiment of the extension element, the first section and the second section each comprising an inner and an outer surface, said first section has its inner surface substantially spaced between 0-10 mm apart from the outer surface of the second section. This embodiment provides for a facilitated assembly of the first and second section.

In one embodiment of the extension element, the first and second fastening means comprises any of wedging, screwing or welding or a combination thereof. This embodiment provides for a stable attachment of the first and second section. Furthermore, this facilitates the attachment of the extension element to a permanently installed frame element in the partition wall.

In one embodiment of the extension element, any of the second section and the first section has a wedged shape so that when attached to each other the second section and the first section is attached by wedging. This embodiment provides for a facilitated and stable attachment of the first and second section that is also flexible, i.e an attachment being easy to operate and for the first and second section to be rotatably adjusted in relation to each other when needed.

In one embodiment of the extension element, the second fastening means comprises at least two screws attaching the second section to the first section by the at least two screws penetrating the first section and connects to the second section, the at least two screws are evenly distributed along the perimeter of the first section. This embodiment provides for a facilitated attachment of the first and second section. Furthermore, this provide for the screws to connect to the second section evenly around its perimeter achieving a stable and a flexible system where adaptations in position of the first and second section are possible to be made when necessary, e.g. variations in desired insulation and/or wall thickness.

In one embodiment of the extension element, the first section and the second section have corresponding shape being either circular or rectangular. This provides for a well fitted extension element and a facilitated assembly of the two sections.

In one embodiment of the extension element, the first section has an overlap of between 0.1-10 cm when enclosing the second section. This enables for a proper attachment of the first section to the second section, and provides for a strengthen assembly.

According to a second aspect of the present invention there is provided a sealing system for an improved heat resistance in a partition wall, said sealing system comprising;

a frame element intended to be permanently secured in a partition wall to form an enclosed passage for one or more cables, wires or pipes through the partition wall, said frame element is formed by a substantially flat member arranged perpendicular to the partition wall such that a shoulder extending from the partition wall is formed, and

an extension element according to claim 1, attached to the shoulder.

The sealing system according to the second aspect of present invention facilitates leading cables, wires or pipes through a partition wall and facilitates insulation of a partition wall. The sealing system also provides for extension of an enclosed passage in the partition wall. Additionally, the sealing system provides the combination of having a proper sealing system for cables, wires or pipes through a partition wall and a facilitated application of insulation with an adaptable thickness onto the partition wall.

In one embodiment of the sealing system, said extension element is at least partly enclosing said shoulder. This embodiment provides for a facilitated installation of the extension element to the fame element and a strong attachment thereof.

In one embodiment of the sealing system, the shoulder comprising an outer surface and the inner surface of said first section is spaced between 0 mm-10 mm apart from the outer surface of said shoulder. This embodiment provides for a facilitated assembly of the first section to the frame element.

In one embodiment of the sealing system, any of the shoulder or first section has a wedged shape so that when attached to each other the shoulder and second section are attached by wedging. This embodiment provides for a facilitated and stable attachment of the extension element to the frame element that is also flexible, i.e an attachment being easy to operate and for the extension element and the frame element to be rotatably adjusted in relation to each other when needed.

In one embodiment of the sealing system, the first fastening means comprises at least two screws, penetrating the first section and connects to the shoulder, the at least two screws are evenly distributed along the perimeter of said first section. This embodiment provides for a facilitated attachment of the extension element to the frame element. Furthermore, this provides for the screws to connect to the shoulder evenly around its perimeter achieving a stable and a flexible system where adaptations in position of the extension element and the frame element are possible to be made when necessary, e.g. variations in desired insulation and/or wall thickness.

In one embodiment of the sealing system, the first section has an overlap of between 0.1-10 cm when enclosing the shoulder. This enables for a proper attachment of the first section to the second section, and provides for a strengthen assembly.

In one embodiment of the sealing system, the space within the frame element and the second section is intended to be fitted with insert blocks of a fire resistant material fitted around said cables, wires or pipes, for sealing around said one or more cables, wires or pipes. This provides a sealing system with proper insulation around the cables, wires or pipes led through the wall by the sealing system.

### BRIEF DESCRIPTION OF THE DRAWINGS

In the following, preferred embodiments will be described with reference to the accompanying drawings, on which:

FIG. 1 schematically illustrates a perspective view of a sealing system comprising a frame element and insert blocks.

FIG. 2a schematically illustrates a perspective view of a sealing system in a partition wall with an assembled extension element in accordance with at least one embodiment of the invention.

FIG. 2b schematically illustrates an exploded view of a sealing system in a partition wall with extension element in accordance with at least one embodiment of the invention.

FIG. 3a schematically illustrates a perspective view of a sealing system in a partition wall with an assembled extension element in accordance with at least one embodiment of the invention.

FIG. 3b schematically illustrates an exploded view of a sealing system in a partition wall with an assembled extension element in accordance with at least one embodiment of the invention.

FIG. 4 schematically illustrates a cross-section view of a sealing system in a partition wall with an extension element in accordance with at least one embodiment of the invention.

### DETAILED DESCRIPTION

The above, as well as additional objects, features and advantages of the present inventive concept, will be better understood through the following illustrative and non-limiting detailed description, with reference to the appended drawings. In the drawings like reference numerals will be used for like elements unless stated otherwise.

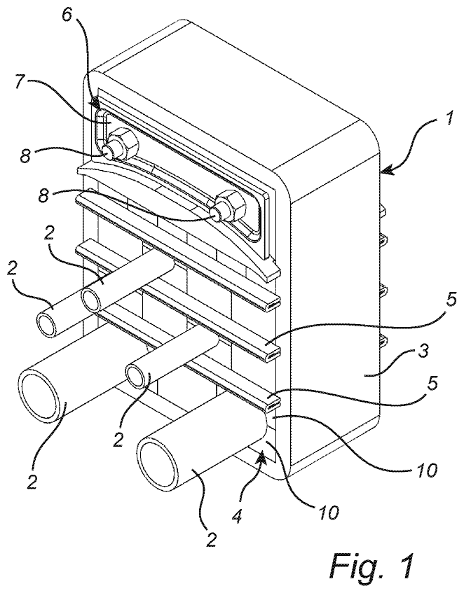

In FIG. 1 a sealing system 1 for sealing of cables 2, wires or pipes extending through a not illustrated partition wall is illustrated. The system involves a metal frame 3 intended to be permanently installed in the partition wall to provide a passage of a predetermined size in the partition wall. The cables, wires or pipes that need to pass through the partition wall are during installation lead through the frame. In order to seal the space within the frame an insert block 4, comprising two substantially identical insert block halves 10, is fitted around each of the cables, wires or pipes extending through the frame. The insert blocks, and the cable, wire or pipe extending through the insert block, are packed in layers within the frame to completely fill the space within the frame. The insert blocks have substantially square cross sectional shape and the outside dimensions of the insert blocks are selected so that a predetermined number of insert blocks have a size corresponding to the space within the frame to fill the space within the frame and provide the desired sealing of the passage in the partition wall. The different layers of insert blocks are separated by a guiding metal plate 5 in order to ensure that the layers remain in the intended position within the frame 3 when pressure is applied on the sealing system. If the number of cables, wires or pipes is less than the number of insert blocks required to fill the space within the frame, the insert blocks could be replaced by a solid elastic rectangular block to fill the remaining spaces within the frame alternatively an insert block could be used. After the blocks are packed side by side in layers in the intended position within the frame a pressure applying device 6 is arranged in the top part of the frame. The pressure applying device comprises a plate 7 arranged on each side of an elastic member and threaded shafts 8 extending through the elastic member. When the elastic member is compressed between the plates by the shafts and nuts arranged on the shaft the elastic element expand such that a pressure is applied on the layer packed within the frame 3 thereby eliminating gaps between the insert blocks and sealing the space within the frame. Different types of pressure applying devices are available and the described device could be replaced by anyone of the available devices.

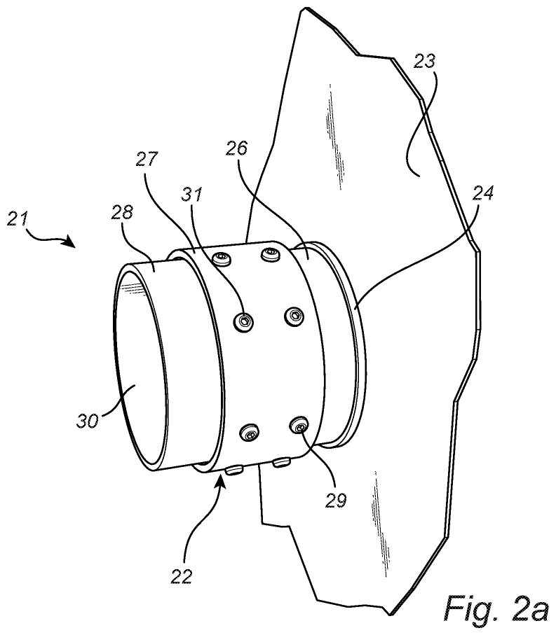

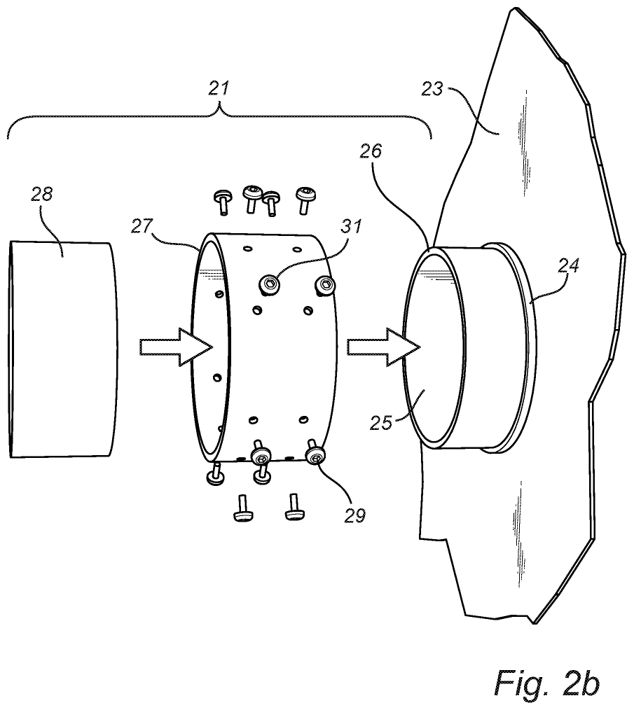

FIG. 2a and FIG. 2b schematically shows a perspective view and an exploded view respectively of a sealing system 21 in a partition wall 23 with an extension element 22 in accordance with at least one example embodiment of the invention.

FIG. 2a and FIG. 2b schematically shows an extension element 22 and a frame element 24 permanently secured in the partition wall 23 to form an enclosed passage 25 for one or more cables, wires or pipes through the partition wall 23. The frame element 24 is formed by a substantially flat member arranged perpendicular to the partition wall such that a shoulder 26 extending from the partition wall 23 is formed. The extension element 22 is intended to enclose said shoulder 26 of said frame element 24 and extend said enclosed passage 25 for one or more cables, wires or pipes.

The extension element 22 is comprising a first 27 and a second section 28. The first section 27 comprising a first fastening means 29 for attaching the extension element 22 to said shoulder 26. The second section 28 is formed so that an extended enclosed passage 30 formed by said second section is substantially equal to the enclosed passage 25 formed by said frame element 24, i.e the extended enclosed passage 30 formed by said second section 28 has substantially the same shape and dimensions as the enclosed passage 25 formed by said frame element 24. In FIG. 2a and FIG. 2b the shape of the frame element 24 is circular and the shape of the second section 28 is also circular having substantially the same diameter as the frame element 24.

FIG. 2a and FIG. 2b illustrate, according to at least one embodiment of present invention, that the extension element 22 may comprise of the first 27 and second section 28 attached to each other by a second fastening means 31 and the first section 27 is then at least partly enclosing said second section 28. The second fastening means 31 could be of any fastening means suitable to assemble the first 27 and second section 28. Although, FIG. 2a and FIG. 2b illustrate the first and second region being separate parts and when attached forming the extension element, the first 27 and second section 28 can be made in one piece forming the extension element 22.

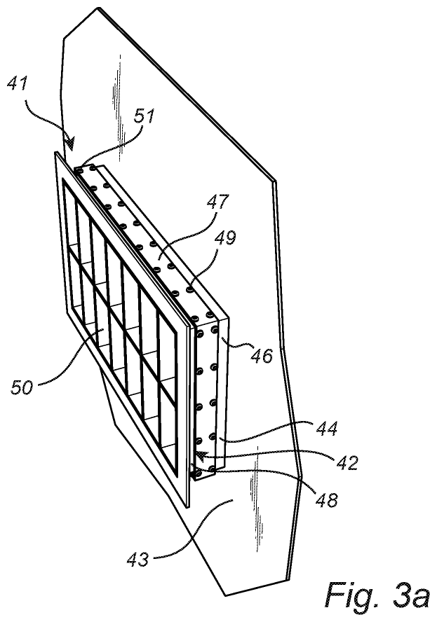

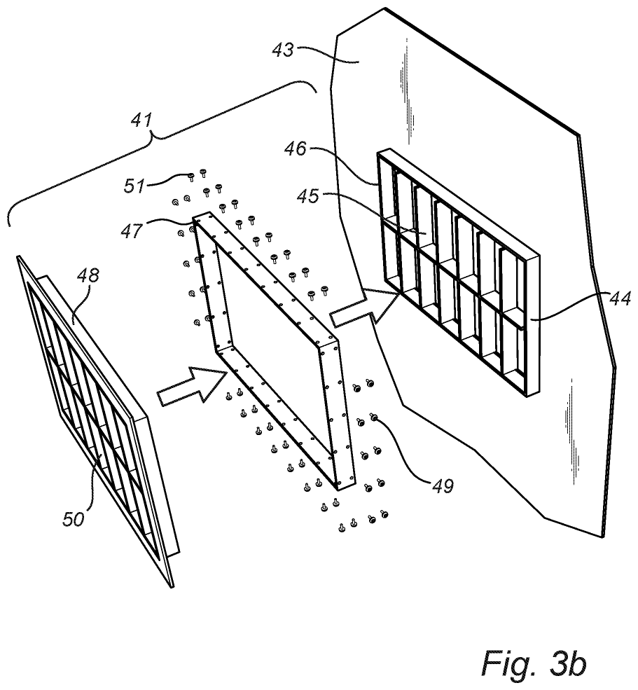

FIG. 3a and FIG. 3b schematically shows a perspective view and an exploded view respectively of a sealing system 41 in a partition wall 43 with an extension element 42 in accordance with at least one example embodiment of the invention.

FIG. 3a and FIG. 3b schematically shows an extension element 42 and a frame element 44 permanently secured in the partition wall 43 to form an enclosed passage 45 for one or more cables, wires or pipes through the partition wall 43, said frame element 42 is formed by a substantially flat member arranged perpendicular to the partition wall such that a shoulder 46 extending from the partition wall 43 is formed, the extension element is intended to enclose said shoulder 46 of said frame element 44 and extend said enclosed passage 45 for one or more cables, wires or pipes, said extension element 42 is comprising;

a first 47 and a second section 48, said first section 47 comprising a first fastening means 49 for attaching the extension element 42 to said shoulder 46, wherein the second section 48 is formed so that an enclosed passage formed by said second section 48 is substantially equal to the enclosed passage 45 formed by said frame element 44, i.e the extended enclosed passage 50 formed by said second section has substantially the same shape and dimensions as the enclosed passage 45 formed by said frame element. The first fastening means 49 could be of any fastening means suitable to attach the first section 47 to the shoulder 46.

In FIG. 3a and FIG. 3b the shape of the frame element 44 is rectangular and the shape of the second section 48 is also rectangular having substantially the same width and height as the frame element 44.

FIG. 3a and FIG. 3b illustrate, according to at least one embodiment of present invention, that the extension element 42 may comprise of the first 47 and second section 48 attached to each other by a second fastening means 51 and the first section 47 is then at least partly enclosing said second section 48. The second fastening 51 means could be of any fastening means suitable to assemble the first 47 and second section 48. Although, FIG. 3a and FIG. 3b illustrate the first and second region being separate parts and when attached forming the extension element, the first and second section can be made in one piece forming the extension element.

Although, FIG. 2 and FIG. 3 illustrates a circular and a rectangular shape respectively, of the frame element 24,44 and the second section 28,48 other shapes of these are also possible, and they could be of any shape suitable for the purpose of the invention.

With reference to FIG. 2 and FIG. 3 they illustrate the first fastening means and second fastening means being could be any of wedging, screwing or welding or a combination thereof.

With reference to FIG. 2 and FIG. 3, the extension element 22,42 according to the invention comprises a heat resistant material, preferably metal, and most preferably steel, aluminum or cast iron.

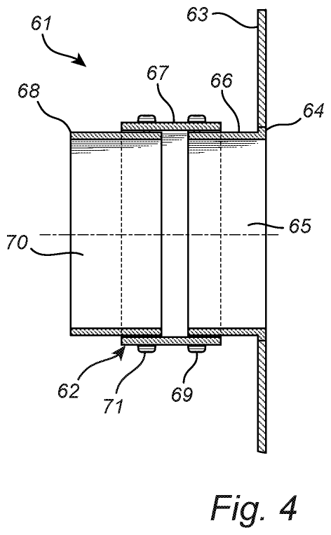

With reference to FIG. 4 a cross-section side view schematically illustrates the sealing system 61 according to at least one example embodiment.

A frame element 64 is permanently secured in a partition wall 63 to form an enclosed passage 65 for one or more cables, wires or pipes through the partition wall 63. A frame element 64 is formed by a substantially flat member arranged perpendicular to the partition wall such that a shoulder 66 extending from the partition wall 63 is formed. An extension element 62 is attached to the frame element 64 by enclosing said shoulder 66 of said frame element 64 and extends said enclosed passage 65 for one or more cables, wires or pipes.

The extension element 62 is comprising a first 67 and a second section 68.

The first section 67 is partly enclosing the second section 68, forming the extension element 62. Further, the first section 67 comprising a first fastening means 69 and the first section 67 is enclosing the shoulder 66 attaching the extension element 62 to the shoulder 66 of said frame element 64 using said first fastening means 69.

The second section 68 is formed so that an extended enclosed passage 70 formed by said second section is substantially equal to the enclosed passage 65 formed by said frame element 64, i.e the extended enclosed passage 70 formed by said second section 68 has substantially the same shape and dimensions as the enclosed passage 65 formed by said frame element 64

The first section 67 enclosing the second section 68 according the invention enables for the first section 67 to receive a shoulder 66 of a frame element 64 and thereby provide an extended enclosed passage 70 formed by said second section 68 that is substantially equal to the enclosed passage 65 formed by said frame element 64.

The first section is enclosing the second section 68 and the shoulder 66 respectively and has an overlap of preferably 0.1-10 cm, i.e the first section has an overlap of 0.1-10 cm when enclosing the second section and the first section has an overlap of 0.1-10 cm when enclosing the shoulder 66.

A larger overlap within the mentioned range may be suitable for attaching the first section 67 to the second section 68 and/or the shoulder 66 respectively using screws or bolts, e.g. there may be at least two screws, penetrating the first section 67 and connects to the shoulder 66, the at least two screws are evenly distributed along the perimeter of said first section 67. A larger overlap within the mentioned range may also be used to attach the first section to the shoulder and/or the first section to the second section respectively through wedging, i.e any of the shoulder or first section and/or first section or second section has a wedged shape so that when attached to each other the shoulder and the first section and/or the first section and the second section is attached by wedging. An overlap within the whole range may be suitable for attaching the first section to the second section, and the first section to the shoulder using welding.

FIG. 4 also schematically illustrates the first section 67 and the second section 68 each having different widths, i.e the first section 67 and the second section 68 each comprising an inner and an outer surface, said first section has its inner surface substantially spaced 0-10 mm apart from the outer surface of the second section.

In the above the invention has mainly been described with reference to a few embodiments. However, as is readily appreciated by a person skilled in the art, other embodiments than the ones disclosed above are equally possible within the scope of the inventive concept, as defined by the appended claims.

1-8. (canceled)

9. A sealing system for an improved heat resistance in a partition wall, said sealing system comprising;
a frame element intended to be permanently secured in a partition wall to form an enclosed passage for one or more cables, wires or pipes through the partition wall, said frame element is formed by a substantially flat member arranged perpendicular to the partition wall such that a shoulder extending from the partition wall is formed wherein the space within the frame element and the second section is intended to be fitted with insert blocks of a fire resistant material fitted around said cables, wires or pipes, for sealing around said one or more cables, wires or pipes, and
an extension element for improving heat resistance of a sealing system installed in a partition wall, the extension element is intended to enclose said shoulder of said frame element and extend said enclosed passage for one or more cables, wires or pipes, said extension element is comprising;
a first and a second section, said first section comprising a first fastening means for attaching the extension element to said shoulder,
wherein the second section is formed so that an extended enclosed passage formed by said second section is substantially equal to the enclosed passage formed by said frame element.

10. The sealing system according to claim 9, wherein said extension element is at least partly enclosing said shoulder.

11. The sealing system according to claim 9, wherein the shoulder comprising an outer surface and the inner surface of said first section is spaced 0-10 mm apart from the outer surface of said shoulder.

12. The sealing system according to claim 9, wherein any of the shoulder or first section has a wedged shape so that when attached to each other the shoulder and the second section is attached by wedging.

13. The sealing system according to claim 9, wherein the first fastening means comprises at least two screws, penetrating the first section and connects to the shoulder, the at least two screws are evenly distributed along the perimeter of said first section.

14. The sealing system according to claim 9, wherein the first section has an overlap of 0.1-10 cm when enclosing the shoulder.

15. (canceled)

16. The sealing system according to claim 9, wherein said first section is at least partly enclosing said second section and said first section is attached to said second section by a second fastening means.

17. The sealing system according to claim 16, wherein the first section and the second section each comprising an inner and an outer surface, said first section has its inner surface substantially spaced 0-10 mm apart from the outer surface of the second section.

18. The sealing system according to claim 16, wherein the first and second fastening means comprises any of wedging, screwing or welding or a combination thereof.

19. The sealing system according to claim 9, wherein any of the second section and the first section has a wedged shape so that when attached to each other the second section and the first section is attached by wedging.

20. The sealing system according to claim 9, wherein the second fastening means comprises at least two screws attaching the second section to the first section by the at least two screws penetrating the first section and connects to the second section, the at least two screws are evenly distributed along the perimeter of the first section.

21. The sealing system according to claim 16, wherein the first section and the second section have corresponding shapes being either circular or rectangular.

22. The sealing system according to claim 16, wherein the first section has an overlap of 0.1-10 cm when enclosing the second section.
